(19) United States
(12) Patent Application Publication
(10) Pub. No.: US 2013/0207466 A1
(43) Pub. Date: Aug. 15, 2013

(54) HOME ENERGY MANAGEMENT APPARATUS AND METHOD FOR INTERWORKING WITH NEW RENEWABLE ENERGY

(71) Applicant: Electronics and Telecommunications Research Institute, (US)

(72) Inventors: Jeong In LEE, Daejeon (KR); Il Woo LEE, Daejeon (KR)

(73) Assignee: Electronics and Telecommunications Research Institute, Daejeon (KR)

(21) Appl. No.: 13/760,567

(22) Filed: Feb. 6, 2013

(30) Foreign Application Priority Data
Feb. 9, 2012 (KR) 10-2012-0013102

(51) Int. Cl. H02J 4/00

(52) U.S. Cl. CPC H02J 4/00
USPC 307/23

(57) ABSTRACT

A home energy management apparatus and method for interworking with a new renewable energy are provided.

### CROSS-REFERENCE TO RELATED APPLICATION

This application claims the benefit of Korean Patent Application No. 10-2012-0013102, filed on Feb. 9, 2012, in the Korean Intellectual Property Office, the disclosure of which is incorporated herein by reference.

### BACKGROUND

1. Field of the Invention

The present invention relates to a home energy management apparatus and method for interworking with a renewable energy, the apparatus and method that supply the new renewable energy when power supply is short, after in-home consuming energy supplied by generation of the new renewable energy, by reselling surplus energy to a power company through inverse power transmission in association with a conventional power system according to a home association type for the new renewable energy or by storing the surplus energy in an energy storage device, as a new renewable energy power supply in the form of a distributed energy resource (DER) such as solar power, wind power, and a fuel cell and an energy storage device are introduced to home.

2. Description of the Related Art

A conventional energy saving technology has been developed in the form of an energy-saving mode in an individual home appliance or commercialized in the form of a home appliance with an energy efficiency label. Currently, a technology has been developed and commercialized in which smart appliances that receive an electricity price, that is, demand response (DR) information, and accordingly operate in a power saving mode at a high-price time zone and operate in a normal mode at a low-price time zone.

However, according to such a passive-type energy saving technology, it is difficult to cope with a sudden increase in demands since real-time reflection of the price information is almost infeasible. Also, the energy saving effect may not be satisfactory. Therefore, if functions of the smart appliances, including an on and off function, are controlled directly by a smart terminal according to an active energy control technology under user permission, real-time response to peak demands may be maximized Accordingly, rolling blackout or large-scale blackout caused by a sudden increase in demands may be prevented while achieving energy saving.

A smart grid denotes a power system to optimize energy efficiency through combination of a grid and information communication infrastructure. Lately, according to situation of the times, the smart grid is drawing attention worldwide and progressed as policies in various countries.

A demand response (DR) refers to a method of providing a consumer with a price signal in real time when a wholesale power price is high or reliability of the system is low, thereby inducing energy saving and providing reward for the saved energy as an incentive. The DR is being spotlighted as a most significant application field for spread of the smart grid technology.

A plurality of home appliance companies throughout the world, for example GE and Whirlpool of U.S.A. and LG of South Korea, are also developing and commercializing smart appliances equipped with functions related to the smart grid.

According to a conventional DR related technology, energy price information is notified through the web, thereby inducing the consumer to directly operate home appliance at a relatively inexpensive time zone. Alternatively, a display of the smart appliance may be equipped with a driving time reservation function along with the energy price information per time zone, so that the smart appliance is operated at the relatively inexpensive time zone.

In relation to the DR, direct load control of the smart appliance may be enabled by energy utility and the like. However, according to the market research related to the smart appliances, most consumers are afraid that their private information such as information on their own home appliances may be exposed to the outside due to the direct load control, and therefore want final control of the appliances to be perform by themselves.

With introduction of the smart grid, efforts are being made for efficient energy use at home and reduction in carbon emission, based on the infrastructure combining the grid and the information communication technology.

A smartmeter is under development, which is for measuring data related to energy to demand management by remotely collecting home energy information based on an advanced metering infrastructure (AMI). According to development of an intelligent home appliance internally equipped with a power measurement and communication function, researches are performed for a home energy management system (HEMS) to monitor and control home energy consumption using the function.

Most of the foregoing technologies are related to technological functions including display, control, management, and verification of energy related data such as home electricity and gas. The foregoing technologies do not verify a procedure of confirming an access trouble through association with the HEMS.

### SUMMARY

An aspect of the present invention provides a home energy management apparatus and method for interworking with a new renewable energy, which provide operation of a system in relation to access confirmation of an associated state between an energy storage system such as a grid, a battery management system (BMS), and a battery and a home energy management system (HEMS) according to access types of new renewable energy facility.

According to an aspect of the present invention, there is provided a home energy management apparatus for interworking with new renewable energy, the apparatus including new renewable energy in the form of a distributed energy resource (DER) in accordance with introduction of a smart grid; and a HEMS providing a monitor and control function related to trading and cost settlement of the new renewable energy through obtainment of environmental information, an association type of the new renewable energy, new renewable energy generation information, a state of an energy storage device, and real-time cost information.

According to another aspect of the present invention, there is provided a home energy management method including selecting an association method of a new renewable energy; determining presence or absence of an energy storage system according to the association method; setting a grid association according to the presence or absence of the energy storage system; and controlling the energy management system after confirming an association state and a communication access state of devices related to the new renewable energy.

### Effect

According to embodiments of the present invention, structures and access states of new renewable energy related devices associated with a home energy management system (HEMS), which have not been considered by the HEMS, are managed. Therefore, since physical access defects and mechanical breakdowns may be checked, reliability of a home energy management function may be increased.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example structure of a home energy management apparatus for interworking with a new renewable energy, according to an embodiment of the present invention;

FIG. 2 is a block diagram illustrating an association structure between an off-grid a new renewable energy and a home energy management system (HEMS), according to an embodiment of the present invention;

FIG. 3 is a block diagram illustrating an association structure between a grid-connected new renewable energy and a HEMS, according to an embodiment of the present invention; and

FIG. 4 is a flowchart illustrating an operational flow of a home energy management method for interworking with a new renewable energy, according to an embodiment of the present invention.

### DETAILED DESCRIPTION

To achieve the aforementioned aspect, the present invention provides a monitor and control function related to trading and cost settlement of a new renewable energy through obtainment of environmental information, an interworking type of the new renewable energy, new renewable energy generation information, a state of an energy storage device, and real-time cost information of when the new renewable energy of a distributed energy resource (DER) is introduced to home, with respect to a home energy management system (HEMS).

Reference will now be made in detail to exemplary embodiments of the present invention, examples of which are illustrated in the accompanying drawings, wherein like reference numerals refer to the like elements throughout. However, the present invention is not limited to the exemplary embodiments.

Hereinafter, a home energy management apparatus and method for interworking with new renewable energy will be described in detail with reference to the drawings.

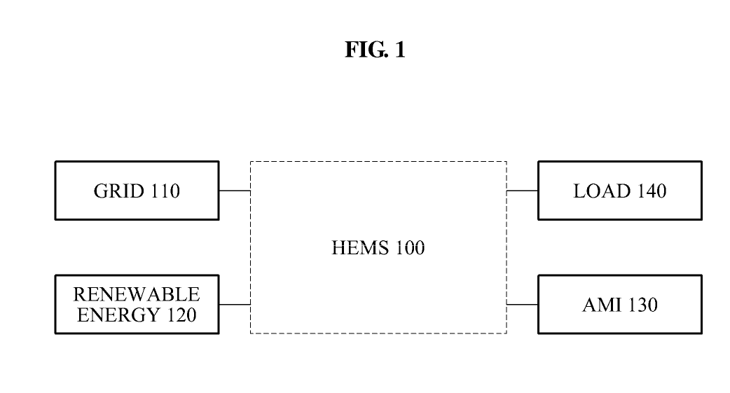

FIG. 1 is a diagram illustrating an example structure of a home energy management apparatus for interworking with new renewable energy, according to an embodiment of the present invention.

Referring to FIG. 1, a HEMS 100 may include a grid 110, a new renewable energy 120, advanced metering infrastructure (AMI) 130, and a load 140.

The grid 110 may supply power to home as an energy source for providing energy.

The new renewable energy 120 may be a DER in accordance with introduction of a smart grid as environment-friendly energy such as solar energy and wind energy.

The AMI 130 may obtain state information related to supply and consumption of energy.

The load 140 may be supplied with the energy from the grid 110 and the new renewable energy 120 through the HEMS 100 and consumes the energy.

According to the embodiment of the present invention, a new renewable energy power supply associated with the HEMS 100 includes two types, that is, an off-grid type and a grid-connected type which will be described hereinafter.

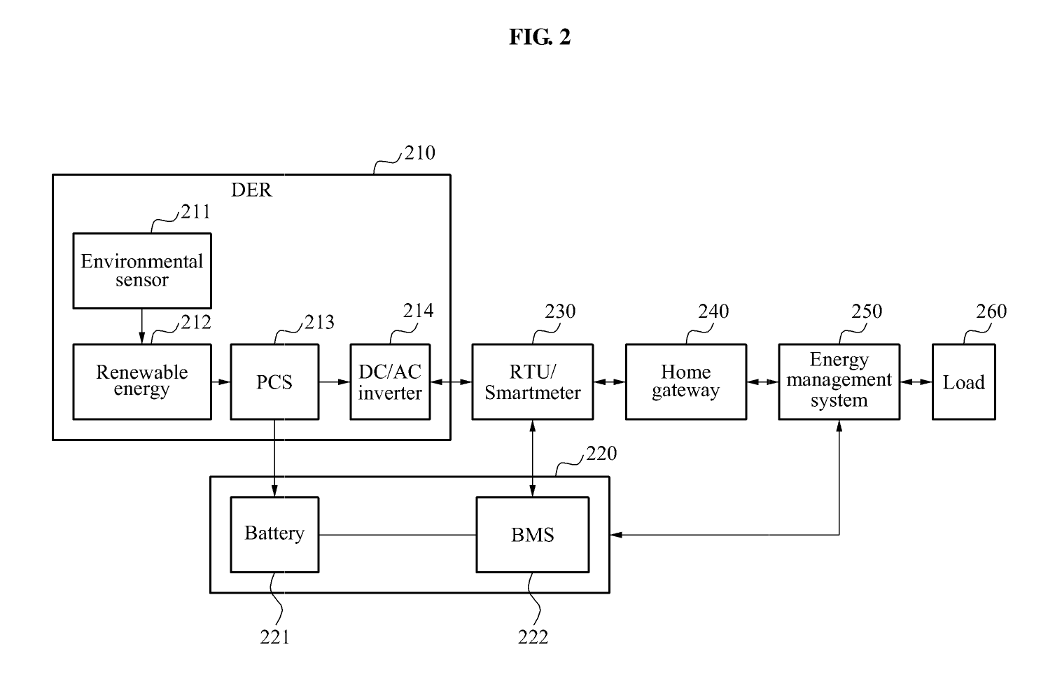

FIG. 2 is a block diagram illustrating an interworking structure between an off-grid a new renewable energy 212 and a home energy management system (HEMS), according to an embodiment of the present invention.

Referring to the structure shown in FIG. 2, a new renewable energy power supply of the off-grid type is in association with the HEMS. The structure may include a small DER 210 including an environment sensor 211, the new renewable energy 212, a power conversion system (PCS) 213, and an inverter 214, an energy storage system 220 including a battery 221 and a battery management system (BMS) 222, a remote terminal unit (RTU) and smartmeter 230, a home gateway 240, an energy management system 250, and a load 260.

The DER 210 may include the environment sensor 211, the new renewable energy 212, the PCS 213, and the inverter 214.

The environment sensor 211 may detect changes of environmental factors such as weather, temperature, wind, illumination and the like.

The new renewable energy 212 may generate energy from sunlight, wind, and the like based on the environmental changes detected by the environmental sensor 211.

The PCS 213 may monitor power quality of the new renewable energy generated by a solar cell and a wind turbine.

The inverter 214 may convert direct current (DC) power generated by the new renewable energy power supply into an alternative current (AC) power.

The energy storage system 220 may include the battery 221 to store the DC power to and the BMS 222.

The battery 221 may store the new renewable energy generated from the PCS 213.

The battery management system 222 may manage the battery 221 by controlling a charging and discharging circuit.

The RTU and smartmeter 230 may obtain power state data through communication with the inverter 214 and the BMS 222.

The home gateway 240 may provide a home network interface necessary for transmission of the power state data.

The energy management system 250 may manage home energy supply and demand for the home energy, through communication with the home gateway 240 and the energy storage system 220.

The load 260 may consume the home energy supplied by the energy management system 250.

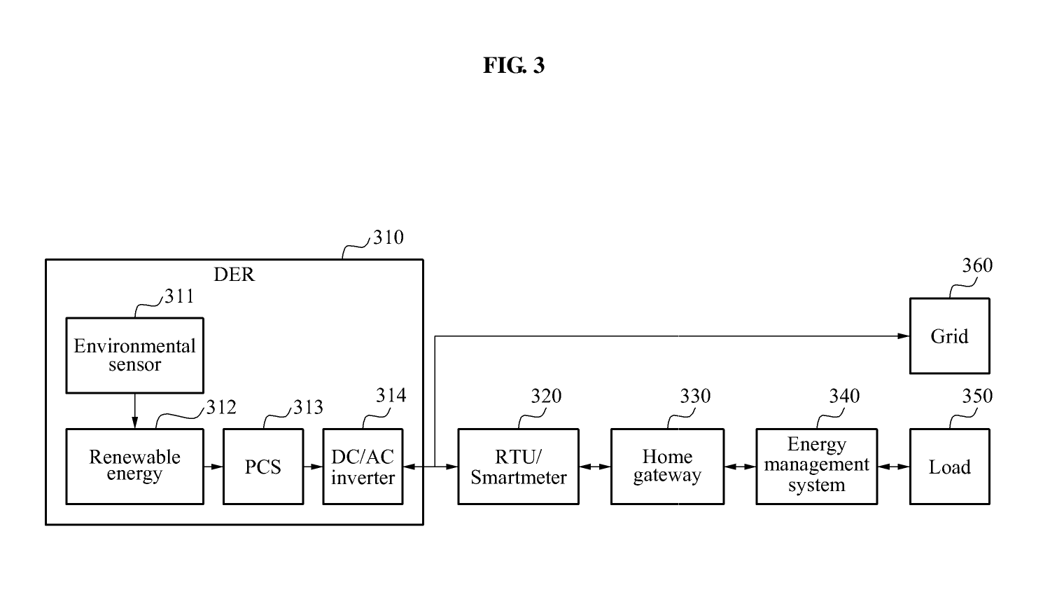

FIG. 3 is a block diagram illustrating an association structure between a grid-connected new renewable energy and a HEMS, according to an embodiment of the present invention.

Referring to the structure shown in FIG. 3, a new renewable energy power supply of the grid-connected type is in association with the HEMS.

A small DER 310 may include an environment sensor 311, a new renewable energy 312, a PCS 313, and an inverter 314.

The environment sensor 311 may detect changes of environmental factors such as weather, temperature, wind, illumination and the like.

The new renewable energy 312 may generate energy from sunlight, wind, and the like based on the environmental changes detected by the environmental sensor 311.

The PCS 313 may monitor power quality of the new renewable energy generated by a solar cell and a wind turbine.

The inverter 314 may convert DC power generated by the new renewable energy power supply into AC power.

When the power generated by the new renewable energy power supply exceeds home energy consumption and therefore a surplus energy is generated, a common grid may transmit the surplus energy to a grid 360, accordingly receiving an incentive, or perform energy trading such as discount of electricity rates.

An RTU and smartmeter 320 may obtain power state data through communication with the inverter 314.

A home gateway 330 may provide a home network interface necessary for transmission of the power state data.

An energy management system 340 may manage home energy supply and demand for the home energy, through communication with the home gateway 330.

A load 350 may consume the home energy supplied by the energy management system 340.

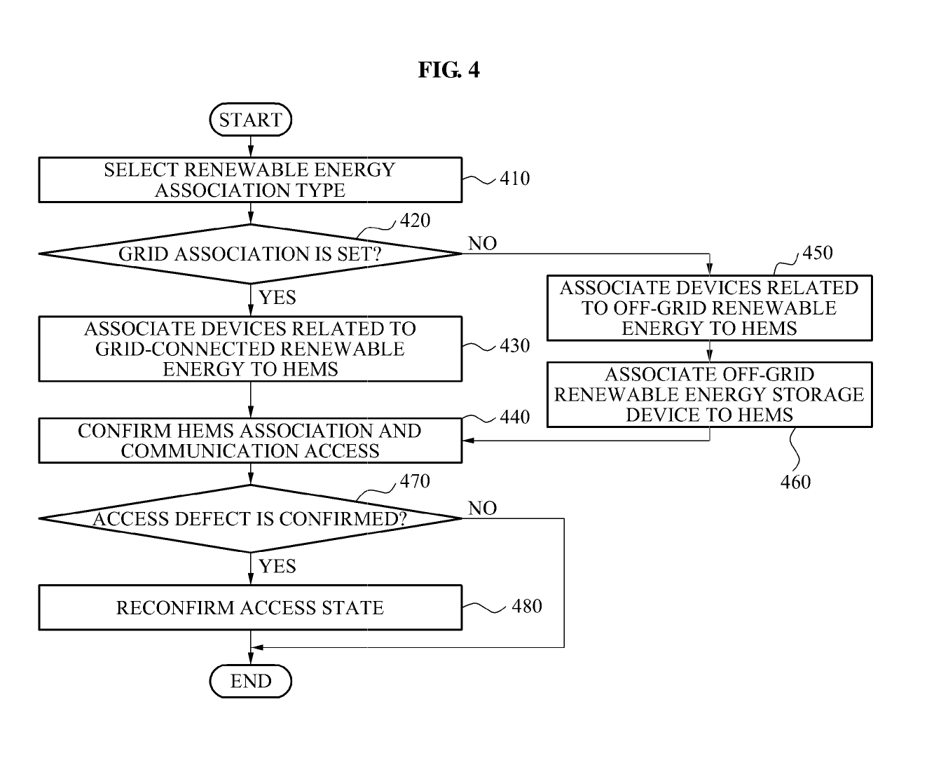

FIG. 4 is a flowchart illustrating an operational flow of a home energy management method for interworking with a new renewable energy, according to an embodiment of the present invention.

Hereinafter, the home energy interwork method for interworking with the new renewable energy will be described in detail.

Referring to FIG. 4, an energy management apparatus may perform a new renewable energy type selection method to provide a selection function according to the type of the new renewable energy. Presence or absence of an energy storage system may be determined according to a new renewable energy association method. Accordingly, association availability of the grid is varied. Therefore, control of the energy management apparatus is performed after confirmation of an association state and a communication access state of the new renewable energy related devices.

The energy management apparatus may select the association method of the new renewable energy in operation 410.

The energy management apparatus may determine presence or absence of the energy storage system according to the association method in operation 420.

The energy management apparatus may set association of a grid according to presence or absence of the energy storage system.

According to an embodiment of the present invention, in operation 430, the energy management apparatus may monitor a generation state of the grid-connected new renewable energy.

The energy management apparatus may monitor a state of an inverter which converts DC power generated by a new renewable energy power supply to AC power.

The energy management apparatus may store the generated new renewable energy in a battery.

The energy management apparatus may obtain state data of the battery.

The energy management apparatus may provide a home network interface necessary for transmission of the state data in association with a grid-connected new renewable energy management apparatus, in operation 440.

According to another embodiment of the present invention, the energy management apparatus may monitor a generation state of an off-grid new renewable energy in operation 450.

The energy management apparatus may monitor a state of an inverter which converts DC power generated by the new renewable energy power supply to AC power.

When the power generated by the new renewable energy power supply exceeds home energy consumption and therefore a surplus energy is generated, the energy management apparatus may transmit the surplus energy to a grid, accordingly receiving an incentive, or perform energy trading such as discount of electricity rates.

The energy management apparatus may obtain power state data of the AC power.

The energy management apparatus may provide a home network interface necessary for transmission of the power state data, in association with an off-grid new renewable energy management apparatus, in operation 460.

The energy management apparatus may confirm the association state and the communication access state of the new renewable energy related devices in operation 470, and reconfirm the access state and control the energy management in operation 480.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A home energy management apparatus for interworking with new renewable energy, the apparatus comprising:
new renewable energy in the form of a distributed energy resource (DER) in accordance with introduction of a smart grid; and
a home energy management system (HEMS) providing a monitor and control function related to trading and cost settlement of the new renewable energy through obtainment of environmental information, an association type of the new renewable energy, new renewable energy generation information, a state of an energy storage device, and real-time cost information.

2. The home energy management apparatus of claim 1, wherein the HEMS comprises:
a grid to supply power to home;
a load to consume supplied energy; and
an advanced metering infrastructure (AMI) to obtain state information related to supply and consumption of energy.

3. The home energy management apparatus of claim 1, wherein the HEMS comprises:
a small DER including an environment sensor to sense weather, temperature, wind, and the like, a new renewable energy power supply which operates based on environmental changes measured by the environmental sensor, a power conversion apparatus to monitor power quality of the new renewable energy, and an inverter to convert direct current (DC) power generated by the new renewable energy power supply to alternating current (AC) power;
an energy storage system including a battery to store the new renewable energy and a battery management system (BMS);
a remote terminal unit (RTU) and smartmeter to obtain data of the energy storage system;
a home gateway to provide a home network interface necessary for transmission of the data;
an energy management system to manage supply and demand of home energy, using the small DER and the energy storage system; and
a load to consume the home energy.

4. The home energy management apparatus of claim 1, wherein the HEMS comprises:
a small DER including an environment sensor to sense weather, temperature, wind, and the like, a new renewable energy power supply which operates based on environmental changes measured by the environmental sensor, a power conversion apparatus to monitor power quality of the new renewable energy, and an inverter to convert direct current (DC) power generated by the new renewable energy power supply to alternating current (AC) power;
a common grid to transmit a surplus energy to a grid when power generated by the new renewable energy power supply exceeds home energy consumption and therefore the surplus energy is generated, thereby receiving an incentive, or to perform energy trading such as discount of electricity rates;
an RTU and smartmeter to obtain data of the small DER;
a home gateway to provide a home network interface necessary for transmission of the data;
an energy management system to manage supply and demand of home energy using the small DER; and
a load to consume the home energy.

5. A home energy management method comprising:
selecting an association method of a new renewable energy;
determining presence or absence of an energy storage system according to the association method;
setting a grid association according to the presence or absence of the energy storage system; and
controlling the energy management system after confirming an association state and a communication access state of devices related to the new renewable energy.

6. The home energy management method of claim 5, wherein the controlling comprises:
monitoring a generation state of the new renewable energy;
monitoring a state of an inverter that converts direct current (DC) power generated by a new renewable energy power supply to alternating current (AC) power;
storing the new renewable energy in a battery;
obtaining state data of the battery; and
providing a home network interface necessary for transmission of the state data.

7. The home energy management method of claim 5, wherein the controlling comprises:
monitoring a generation state of the new renewable energy;
monitoring a state of an inverter that converts DC power generated by a new renewable energy power supply to AC power;
transmitting a surplus energy to a grid when power generated by the new renewable energy power supply exceeds home energy consumption and therefore the surplus energy is generated, thereby receiving an incentive, or performing energy trading such as discount of electricity rates;
obtaining state data of the battery; and
providing a home network interface necessary for transmission of the state data.
